(19) United States
(12) Patent Application Publication
(10) Pub. No.: US 2007/0037445 A1
(43) Pub. Date: Feb. 15, 2007

(54) Tubular compliant shape memory alloy actuators

(76) Inventors: Byong-Ho Park, Cincinnati, OH (US); David Liang, Menlo Park, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/487,152

(22) Filed: Jul. 13, 2006

Related U.S. Application Data
(60) Provisional application No. 60/698,737, filed on Jul. 13, 2005.

(51) Int. Cl. H01R 9/05

(52) U.S. Cl. 439/578

(57) ABSTRACT

A shape memory alloy (SMA) actuator made from tubular structures is disclosed. The current invention is a tubular monolithic SMA actuator made from a tubular monolithic SMA substrate of NiTi, CuAlNi, CuAl, CuZnAl, TiV, or TiNb. The tubular monolithic SMA actuator has a first end, a second end and a middle portion, and can be made out or a substrate with a cross-section shape such as a circle, an ellipse, a rectangle or any irregular shape. The middle portion is formed into an actuator pattern that maintains unity and electrical continuity, along the path of the actuator pattern, with the first end and second end. The actuator pattern can be any number of patterns, for example, a Greek key pattern or a zigzag pattern. A first electrode is optionally formed in the first end and a second electrode is formed in the second end of the tubular monolithic SMA actuator.

### FIELD OF THE INVENTION

The invention relates generally to medical devices. More particularly, the invention relates to steerable active catheters, actuators for active catheters, and techniques for manufacturing such devices.

### BACKGROUND

There are many medical applications requiring a catheter that can intricately move through restricted environments such as coronary blood vessels, or deliver therapeutic agents precisely into a target. Steerable catheters have been passively controlled remotely by mechanical pull wires. These catheters can be effective for limited applications requiring simple motions. However, it is essential to have intricate and precise motions inside a small space to address given specifications in minimally invasive surgery. Accordingly, considerable research in academic institutions and industry has been directed toward developing active catheters. An ideal active catheter has multiple in-situ actuators optimally arranged and electrically driven, and does not have issues normally involved with a passive catheter such as friction and one-to-one motion delivery from proximal to distal end. Therefore, an active catheter is a preferred solution to meet the specifications in intravascular intervention and minimally invasive surgery.

The main limitation in current active catheter technology is the need to have actuators capable to provide enough force and displacement in small size. Shape memory alloy (SMA) is one type of technology proposed for use in active catheter actuators. SMA is known for large displacement with relatively high force output. However, a remaining challenge is to be able to provide actuators with three dimensional shape in a small scale. Currently, wire shape actuators are utilized in certain applications, but due to its fixed shape it is difficult to apply in many other applications, especially intravascular intervention and minimally invasive surgery. There exists a technology using thin films to fabricate micro-valves. Similarly, this technology is based on fixed shape, thin films, thus are not easy to implement in an active catheter which naturally has three-dimensional tubular form. Accordingly, there is a need to develop a tubular monolithic shape memory alloy actuator to overcome the current shortcomings in the art.

### SUMMARY OF THE INVENTION

A shape memory alloy (SMA) actuator made from tubular structures is presented to overcome the limitations of the existing technology, where the current invention is a tubular monolithic SMA actuator made from a tubular monolithic SMA. The tubular monolithic SMA can be made from NiTi, CuAlNi, CuAl, CuZnAl, TiV, or TiNb, for example. In a preferred embodiment, the tubular monolithic SMA actuator has a first end, a second end and a middle portion. The tubular monolithic SMA can have a cross-section shape such as a circle, an ellipse, a square, a rectangle, a parallelogram or a polygon. The middle portion is formed into an actuator pattern that maintains unity and electrical continuity, along the path of the actuator pattern, with the first end and second end of the tubular monolithic SMA actuator. The actuator pattern can be a generally Greek key pattern or a zigzag actuator any irregular pattern for example. A first electrode is formed in the first end and a second electrode is formed in the second end of the tubular monolithic SMA actuator. The first electrode and second electrode are made from the tubular monolithic SMA. In one embodiment of the invention, the first end, second end and middle portion are of generally partial-tubular shape.

In another embodiment of the invention, the tubular monolithic SMA actuator is a tubular monolithic SMA actuator having a first end, a second end and a middle portion, where the first end is segmented, and the middle portion is formed into multiple actuator patterns that maintain unity and electrical continuity, along the paths of the actuator patterns, with each segmented first end and the second end of the tubular monolithic SMA actuator. In this embodiment, the tubular monolithic SMA can have a cross-section shape such as a circle, an ellipse, a square, a rectangle, a parallelogram or a polygon, where the tubular monolithic SMA can be NiTi, CuAlNi, CuAl, CuZnAl, TiV, or TiNb, to name a few. The segmented first end of the tubular monolithic SMA actuator is generally partial-tubular shape or segmented tubular shape, and the second end is generally tubular shape having an open span. In another embodiment of the invention, the second end is generally tubular shape without an open span. In these embodiments, the actuator pattern can be a generally Greek key pattern, a zigzag pattern or any irregular pattern. A first electrode is formed in each segmented first end, and a second electrode is formed in the second end. Here, the first electrode and second electrode are made from the tubular monolithic SMA.

In another embodiment of the current invention, the tubular monolithic SMA actuator has a first end, a second end and a middle portion, where the first end, second end and middle portion have a predetermined electrical resistance and a mechanical stiffness. The tubular monolithic SMA has a cross-section shape such as a circle, an ellipse, a square, a rectangle, a parallelogram or a polygon, to name a few. The tubular monolithic SMA can be NiTi, CuAlNi, CuAl, CuZnAl, TiV, or TiNb, for example. The tubular monolithic SMA actuator of this embodiment has support bands sequentially formed about the middle portion of the tubular monolithic SMA, where the support band has a support band first edge and a support band second edge. Multiple actuator patterns are formed in the middle portion, where each actuator pattern has an actuator pattern first end connected to the support band first edge and an actuator pattern second end connected to an actuator pattern electrode, where the actuator pattern electrode is detached from the middle portion. The actuator pattern can be a generally Greek key pattern, a zigzag pattern or any irregular pattern. Here, the actuator pattern is formed to have a higher electrical resistance relative to the electrical resistance of the middle portion. Additionally, multiple bending elements are formed in the middle portion, where the bending elements connect the first edge of a support band to the second edge of an adjacent support band. The bending elements are positioned about the tubular monolithic SMA actuator circumference and between the actuator patterns, where the bending element is formed to have lower mechanical stiffness than the support band end, and further the bending element is formed to have a lower electrical resistance relative to the electrical resistance of the actuator pattern. An electrode is optionally formed in the first end or in the second end of the monolithic SMA actuator. In this embodiment, an electrode is formed in the actuator pattern second end, where electrical continuity exists along the middle portion from the actuator pattern electrode to the first end or to the second end of the tubular monolithic SMA actuator. The electrodes are made from the tubular monolithic SMA.

A method of fabricating a tubular monolithic SMA actuator includes providing a tubular monolithic SMA having a first end, a second end and a middle portion, and forming an actuator pattern in the middle portion, where the tubular monolithic SMA can be NiTi, CuAlNi, CuAl, CuZnAl, TiV, or TiNb, to name a few. The tubular monolithic SMA has a cross-section shape such as a circle, an ellipse, a square, a rectangle, a parallelogram or a polygon, to name a few. The actuator pattern maintains unity and electrical continuity, along the path of the actuator pattern, with the first end and second end of the tubular monolithic SMA actuator. The actuator pattern can be a generally Greek key pattern, a zigzag pattern or any irregular pattern. An electrode is formed in the first end and in the second end of the tubular monolithic SMA actuator. The tubular monolithic SMA actuator is formed using fabrication methods such as laser machining, electric discharge machining, mechanical machining, stamping, dicing and chemical etching. The electrodes are made from the tubular monolithic SMA.

In another embodiment, a method of fabricating a tubular monolithic SMA actuator includes providing a tubular monolithic SMA having a first end, a second end and a middle portion, where the first end is segmented. The tubular monolithic SMA has a cross-section shape such as a circle, an ellipse, a square, a rectangle, a parallelogram or a polygon, for example, where the tubular monolithic SMA can be NiTi, CuAlNi, CuAl, CuZnAl, TiV, or TiNb, to name a few. A pair of actuator patterns are formed in the middle portion where, the middle portion maintains unity and electrical continuity, along the paths of the actuator patterns, with each segment of the first end and with the second end of the tubular monolithic SMA actuator. The actuator pattern can be a generally Greek key pattern, a zigzag pattern, or any irregular pattern. An electrode is formed in each segment of the first end, and an electrode is formed in the second end. In this embodiment of the method of forming the tubular monolithic SMA actuator, machining methods such as laser machining, electric discharge machining, mechanical machining, stamping, dicing and chemical etching can be used, to name a few. The electrodes are made from the tubular monolithic SMA.

In another embodiment of the method of fabricating a tubular monolithic SMA actuator, the method includes providing a tubular monolithic SMA having a first end, a second end and a middle portion, where the first end, second end and middle portion have a predetermined electrical resistance and a mechanical stiffness. The tubular monolithic SMA has a cross-section shape such as a circle, an ellipse, a square, a rectangle, a parallelogram or a polygon, for example, where the tubular monolithic SMA can be NiTi, CuAlNi, CuAl, CuZnAl, TiV, or TiNb, to name a few. Multiple support bands are formed sequentially about the middle portion of the a tubular monolithic SMA actuator, where the support band has a support band first edge and a support band second edge. Multiple actuator patterns are formed in the middle portion, where the actuator pattern has a pattern first end connected to the support band first edge and a pattern second end connected to an actuator pattern electrode that is detached from the middle portion. The actuator pattern has a generally Greek key pattern, a zigzag pattern or any irregular pattern. Multiple bending elements are formed in the middle portion, where the bending elements have a bending element first end attached to the support band first edge and a bending element second end attached to an adjacent support band second edge. An electrode is formed in the first end or in the second end of the tubular monolithic SMA actuator. An actuator pattern electrode is formed with the actuator pattern second end, where electrical continuity exists along said middle portion from the actuator pattern second end to the first end or said second end of the tubular monolithic SMA actuator. The electrodes are made from the tubular monolithic SMA. The tubular monolithic SMA actuator is formed using fabrication methods such as laser machining, electric discharge machining, mechanical machining, stamping, dicing or chemical etching, for example.

A method of actuating a tubular monolithic SMA actuator is presented, where the method includes providing a passive tubular body, providing at least one tubular monolithic SMA actuator and aligning the tubular monolithic SMA actuators along the passive tubular body. The method further includes independently activating the tubular monolithic SMA actuators by supplying current to electrodes on the tubular monolithic SMA actuators, and heating the tubular monolithic SMA actuator with the supplied current, where the heat causes the tubular monolithic SMA actuator and the passive tubular body to bend in desired a direction and to a desired degree. In this embodiment, the tubular monolithic SMA actuator envelopes a passive body having a generally tubular shape with a cross-section similar to the tubular monolithic SMA actuator, where the passive body is made from material such as polymers, metal alloy or nitinol, to name a few. Here, the passive body has a lower mechanical stiffness than the tubular monolithic SMA actuator.

With the use of the tubular monolithic SMA actuator, physicians are able to precisely control the motion of a catheter while navigating inside blood vessels or in the heart. The current invention enables intricate manipulations inside small spaces, for instance, in medial applications it is a useful tool to navigate through human blood vessels, or be used in cardiovascular intervention and cerebrovascular treatment in a minimally invasive fashion.

By implementing the current invention, a small tool can be made to generate complicated motions. For example, the current invention can be useful for manipulating tools for rescue or military operations, or when inspecting an object inside or trapped by an obstruction. Further, the current invention can be used to deliver and manipulate a camera through a small opening and inspect inner spaces.

### BRIEF DESCRIPTION OF THE FIGURES

The objectives and advantages of the present invention will be understood by reading the following detailed description in conjunction with the drawing, in which:

FIGS. 1a-1c show tubular monolithic shape memory alloy actuators having partial tubular shape according to the present invention.

FIGS. 2a-2d show tubular monolithic shape memory alloy actuators having segmented tubular shape with a pair of actuator patterns according to the present invention.

FIGS. 3a-3b show tubular monolithic shape memory alloy actuators having segmented tubular shape with three actuator patterns according to the present invention.

FIG. 4 shows a tubular monolithic shape memory alloy actuator having multiple actuator patterns and bending elements.

FIGS. 5a-5b show tubular monolithic shape memory alloy actuators incorporated with passive tubular bodies.

FIGS. 6-8 show diagrams of the steps for fabricating tubular monolithic shape memory alloy actuators depicted in FIGS. 1-5

FIG. 9 shows a diagram of the steps for actuating a tubular monolithic shape memory alloy actuator depicted in FIG. 5a.

FIG. 10 shows a diagram of the steps for actuating a tubular monolithic shape memory alloy actuator depicted in FIG. 5b.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

A tubular monolithic shape memory alloy (SMA) actuator for active catheter applications is provided, where one or more of the tubular monolithic SMA actuators are utilized as main actuators for active catheter applications including intravascular intervention and minimally invasive surgery. Tubular monolithic SMA actuators, according to the present invention can be fabricated out of a tubular SMA structure using fabrication methods such as laser machining, electric discharge machining, mechanical machining, stamping, dicing and chemical etching. Fundamentally a tubular monolithic SMA actuator is formed from a pre-fabricated SMA tube having a shape memory behavior with a certain transition temperature. Considering the inherent shape of the blood vessel, tubular, it is favorable and more efficient to make actuators out of a tubular form. According to one embodiment of the current invention, tubular monolithic SMA actuators can be fabricated directly out of tubular monolithic SMA's such as NiTi alloy (nitinol). Useful tubular monolithic SMAs' are selected based on having a transition temperature above room temperature and with a transition temperature range from about 40° C. to 120° C., where other useful alloys can include CuAlNi, CuAl, CuZnAl, TiV, and TiNb, for example. According to the preferred embodiment of the current invention, tubular monolithic SMA actuators can be actively turned on and off as actuators by electronically heating with current while used inside the human body, where electrical wires are connected to the electrodes and current is supplied over certain time periods such as 0.1 Hz, 1 Hz, or 10 Hz (typically with 1% to 50% duty cycles).

The SMA actuator has an actuator pattern that is customized to exert an appropriate displacement and high force. The SMA actuator goes through a phase transformation, Martensite to Austenite, when electronically heated with current. The actuator has a relatively lower mechanical stiffness in Martensite, but its stiffness substantially increases in Austenite when activated. Therefore, the actuator pattern is designed to generate a large displacement and high force by having a phase transformation between Martensite and Austenite when heated with electric current. Generally its motion can be contraction and extension, but depending on the shape of the actuator pattern, it can also generate various motions such as rotating, bending or sweeping. Once its overall shape is designed, the tubular SMA actuator has design parameters such as width and thickness. The thickness of the actuator is selected by the thickness of a pre-fabricated SMA substrate, and the width is determined by how it is processed during fabrication. Compared to traditional SMA actuators based on a wire or spring, the tubular SMA actuator is much easier to adjust or regulate its characteristics such as stiffness and displacement by shaping the actuator pattern in any customized form with various dimensions. Laser machining, using lasers such as a Nd:YAG laser, can be used to fabricate the monolithic tubular SMA actuators out of nitinol tubing. The laser machining typically has one radial axis for rotational motion and one longitudinal axis for translational motion, commonly used to fabricate stents for cardiovascular interventions. Laser-cut actuator feature sizes are about 10 to 500 microns. According to the current invention, useful tubular monolithic SMA thicknesses can be about 10 to 500 microns, and the tubular diameters can be about 100 microns to 5 mm.

According to the current invention, tubular monolithic SMA actuators can be used as individual actuators that are separately assembled along a passive tubular body for an active catheter. Further, multiple tubular monolithic SMA actuators can be assembled along a passive tubular body for an active catheter. The tubular monolithic SMA actuators and passive tubular body are preferably fabricated separately, aligned and assembled together. The passive tubular structure can be made out of various materials such as plastics, metals or nitinol, preferably a superelastic material. If the passive tubular structure is made of an electrically conductive material, an insulation layer or material needs to be placed between the passive structure and the tubular SMA actuators to prevent an electric short circuit. The insulation layer can be applied by coating on the surface of the passive tubular structure or the tubular SMA actuators. Also the insulation can be applied by placing a tubular insulation structure between the passive body and the tubular SMA actuators. These tubular monolithic SMA actuators are activated independently by supplying current and electrically heating across actuator patterns through wired attached to electrodes integrally formed from the tubular monolithic substrate and connected to the actuator patterns. Activation of the tubular monolithic SMA actuators selectively bends the tubular body structure so as to enable intricate motions with various bending modes in the active catheter. Selective dexterity, degrees of freedom and radius of curvature are enabled by use of different numbers or configurations of tubular monolithic SMA actuators along the tubular passive body.

Alternatively, according to one embodiment of the current invention, tubular monolithic SMA actuators can be used as a basic body structure for the active catheter, where the passive tubular body will have tubular monolithic SMA actuators integrated during the fabrication in a single process. This embodiment has an advantage in eliminating additional fabrication steps involved in aligning and bonding the SMA actuators with a passive tubular structure. It is easier, efficient and more economical to fabricate the pre-assembled SMA actuators with a passive tubular structure out of a single monolithic SMA tube. By individually controlling an array of tubular monolithic SMA actuators, intricate motions can be achieved, particularly within the confined space of intravascular intervention.

The tubular monolithic SMA actuators can have actuator patterns such as a coil, zigzag, Greek key or any irregular pattern made from the tubular monolithic SMA, where the shape memory behavior is the main actuation mechanism. By selecting appropriate tube diameter, wall thickness and feature geometry as design parameters, tubular monolithic SMA actuators can be made to meet desired requirements in output force and displacement.

Tubular monolithic SMA actuators allow physicians to actively control a catheter to generate various bending modes. Physicians are able to precisely control the motion of the catheter while navigating inside blood vessels or in the heart. Intricate manipulations inside small spaces while being minimally invasive are enabled with the tubular monolithic SMA actuators.

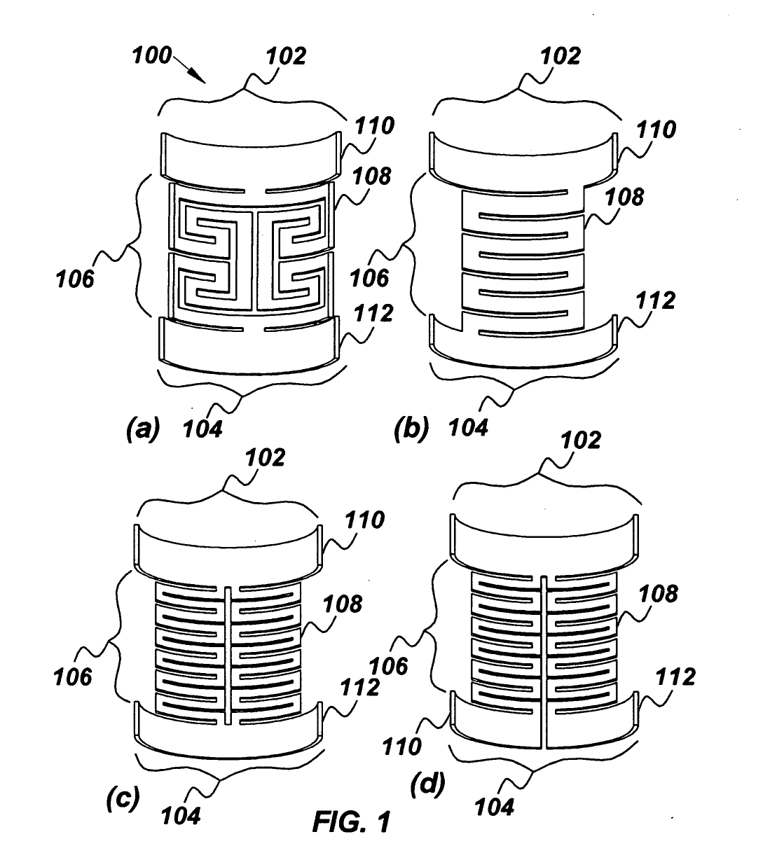

Referring now to the drawings, FIGS. 1a-1d depict perspective views of a shape memory alloy (SMA) actuator 100 made from tubular structures, where the current invention is a tubular monolithic SMA actuator made from a tubular monolithic SMA. The tubular monolithic SMA can be NiTi, CuAlNi, CuAl, CuZnAl, TiV, or TiNb, for example. The tubular monolithic SMA actuator 100 has a first end 102, a second end 104 and a middle portion 106. The tubular monolithic SMA actuator 100 can be made out of a substrate with a cross-section shape such as a circle, an ellipse, a square, a rectangle, a parallelogram or a polygon. The middle portion 106 is formed into an actuator pattern 108 that maintains unity and electrical continuity, along the path of the actuator pattern, with the first end 102 and second end 104 of the actuator. The actuator pattern 108 can be a generally Greek key pattern, a zigzag pattern or any irregular pattern. A first electrode 110 is formed in the first end 102 and a second electrode 112 is formed in the second end 104 of the tubular monolithic SMA actuator 100. The first electrode 110 and second electrode 112 are made from the tubular monolithic SMA. In the embodiment of the invention depicted in FIGS. 1a-1d, the first end 102, second end 104 and middle portion 106 are of generally partial-tubular shape. Further, depicted in FIG. 1a is a tubular monolithic SMA actuator 100 having an actuator pattern 108 of generally Greek key pattern, while FIG. 1b depicts a tubular monolithic SMA actuator 100 having an actuator pattern 108 of generally zigzag pattern, and FIG. 1c depicts a tubular monolithic SMA actuator 100 having an actuator pattern 108 of generally multi-zigzag pattern. Alternatively, the electrode can be placed in any position next to the actuator pattern. For instance, the first electrode and the second electrode can be located in the same end as shown in FIG. 1d which depicts a tubular monolithic SMA actuator 100 having an actuator pattern 108 of generally multi-zigzag pattern, where the first electrode 110 and second electrode 112 are formed with a split second of the tubular monolithic SMA actuator 100, where it is understood that the electrodes (110, 112) could optionally be formed on the first end 102. Practically the electrode can be positioned in any angle relative to the actuator pattern, and can be optionally formed on one or both ends (102, 104).

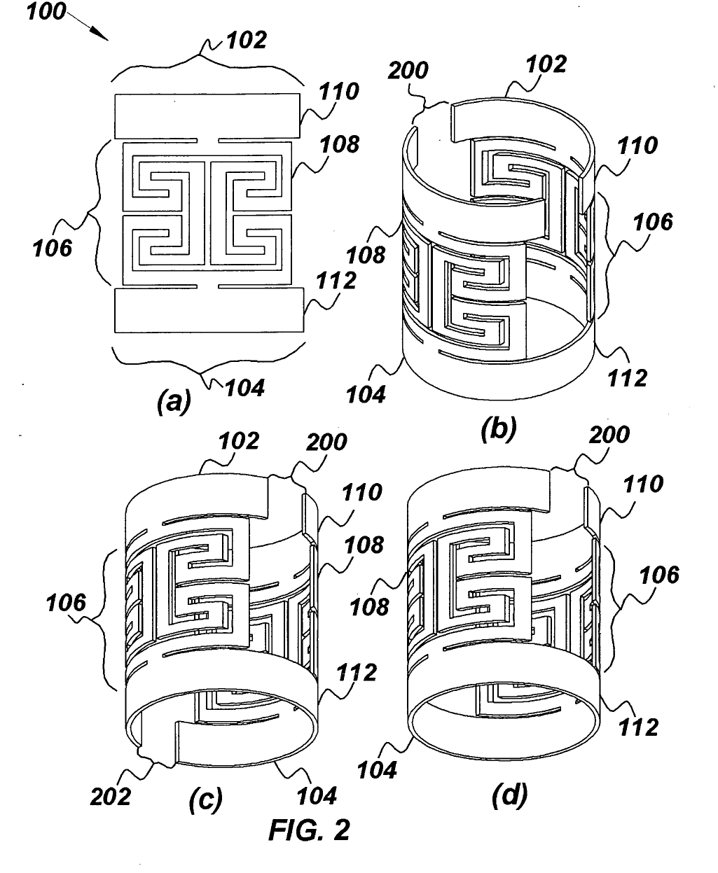

FIGS. 2a-2d depict further embodiments of the invention, where FIG. 2a is side elevation view of a tubular monolithic SMA actuator 100 having a first end 102, a second end 104 and a middle portion 106. In the embodiment depicted in FIG. 2b, the monolithic structure is similar to the embodiment of FIG. 2a, however the first end 102 has a pair of first end open spans 200 to create a segmented first end 102, and the middle portion 106 is formed into a pair of actuator patterns 108 that maintain unity and electrical continuity, along the paths of the actuator patterns 108, with each segment of the first end 102 and the second end 104 of the tubular monolithic SMA actuator 100. In the embodiment depicted in FIGS. 2c and 2d, the monolithic tubular structure is similar to the embodiments of FIGS. 2a and 2b, however further depicted in FIG. 2c, the second end 104 has a second end open span 202, where the combination of the segmented fist end 102 and the second end open span 202, enable the tubular monolithic SMA actuator 100 to be spread open for release around a passive tubular body (not shown) such as a catheter and the tubular monolithic SMA actuator 100 can be held in place using a frictional fit or adhesives, for example. The segmented first end 102 of the tubular monolithic SMA actuator 100 is generally partial-tubular shape, and the second end 104 is generally tubular shape having a second end open span 202. Alternatively, the tubular monolithic SMA actuator 100 has a second end 104 that is continuous and uninterrupted, as depicted in FIG. 2d, where the tubular monolithic SMA actuator 100 receives a passive tubular body there through (not shown), such as a catheter, and the monolithic tubular SMA actuator 100 can be held in place using a frictional fit or adhesives. In these embodiments, the tubular monolithic SMA actuator 100 can be made out of a substrate with a cross-section shape such as a circle, an ellipse, a square, a rectangle, a parallelogram or a polygon, where the tubular monolithic SMA can be NiTi, CuAlNi, CuAl, CuZnAl, TiV, or TiNb, to name a few. In the embodiments depicted in FIGS. 2a-2d, the actuator pattern can be a generally Greek key pattern, a zigzag pattern or any irregular pattern. A first electrode 110 is formed in each segmented first end 102, and a second electrode 112 is formed in the second end 104. Here, the first electrode 110 and second electrode 112 are made from the tubular monolithic SMA. Practically the electrode can be positioned in any angle relative to the actuator pattern, and can be optionally formed on one or both ends (102, 104).

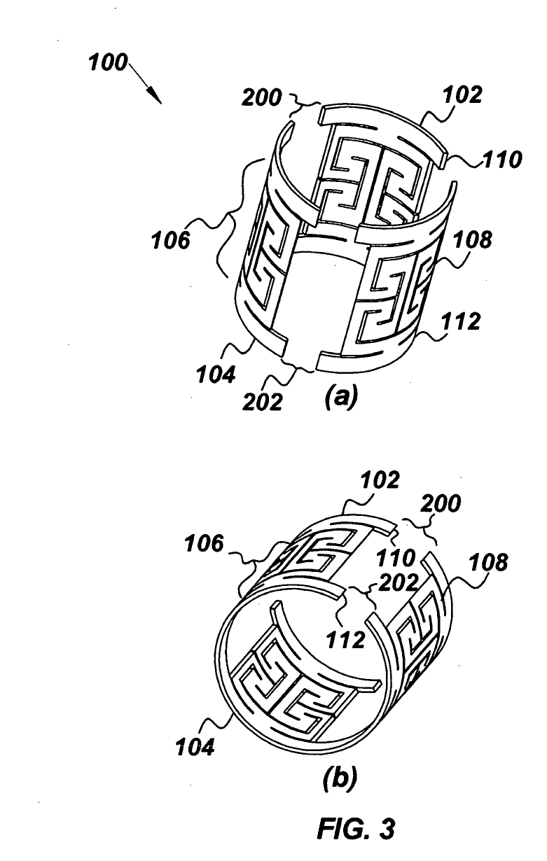

FIGS. 3a and 3b are perspective views depicting a further embodiment of the tubular monolithic SMA actuator 100 that is similar to the embodiments depicted in FIGS. 2a-2c, however, the first end 102 has three segments created by three first end open spans 200 and the second end 104 has a second end open span 202. A first electrode 110 is formed in each of the segments of the first end 102, and a second electrode 112 is formed in the second end 104. As depicted, three actuator patterns 108 are formed in the middle portion 106. The combination of the segmented fist end 102 and the second end open span 202, enable the tubular monolithic SMA actuator 100 to be spread open for release around a passive tubular body (not shown) such as a catheter and the tubular monolithic SMA actuator 100 can be held in place using a frictional fit or adhesives, for example. It should be apparent to one skilled in the art that the number and orientation of the segments can be arranged in many different configurations without departing from the spirit of the current invention. Alternatively, the actuator patterns can be heated indirectly, for example, using a thermistor or other non-contact heating, so there is no need to directly form the electrodes on the actuators. Practically the electrode can be positioned in any angle relative to the actuator pattern, and can be optionally formed on one or both ends (102, 104).

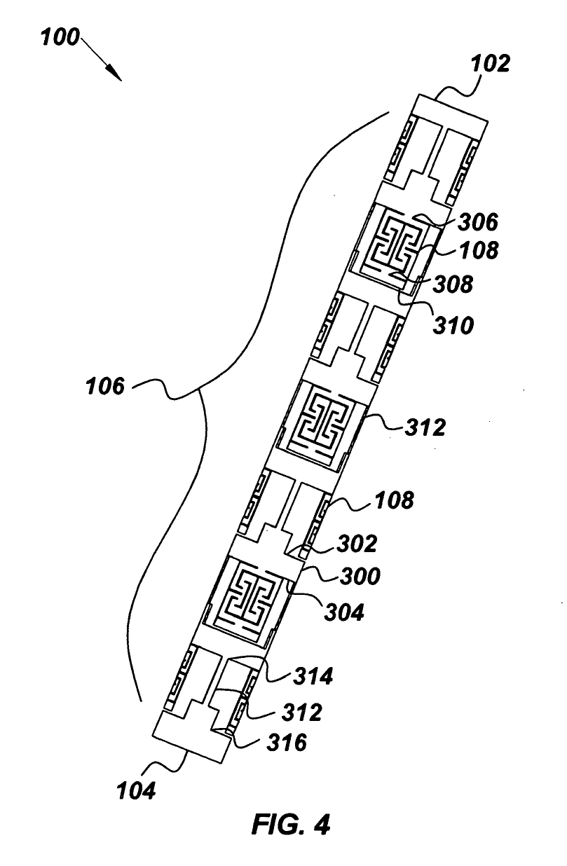

FIG. 4 depicts a perspective view of a further embodiment of the current invention, where the tubular monolithic SMA actuator 100 has a first end 102, a second end 104 and a middle portion 106, where the first end 102, second end 104 and middle portion 106 have a predetermined electrical resistance and a mechanical stiffness. The tubular monolithic SMA actuator 100 is made out of a substrate with a cross-section shape such as a circle, an ellipse, a square, a rectangle, a parallelogram or a polygon, to name a few. The tubular monolithic SMA can be NiTi, CuAlNi, CuAl, CuZnAl, TiV, or TiNb, for example. In the embodiment depicted in FIG. 4, the tubular monolithic SMA actuator 100 has support bands 300 sequentially formed about the middle portion 106 of the tubular monolithic SMA actuator 100, where the support band 300 has a support band first edge 302 and a support band second edge 304. Multiple actuator patterns 108 are formed in the middle portion 106, where each actuator pattern 108 has an actuator pattern first end 306 connected to the support band first edge 302 and an actuator pattern second end 308 connected to an actuator pattern electrode 310 detached from the middle portion 106. The actuator pattern 108 can be a generally Greek key pattern, a zigzag pattern or any irregular pattern. Here, the actuator pattern 108 is formed to have a higher electrical resistance relative to the electrical resistance of the middle portion 106 to make sure it is effective in heating the actuator pattern 108. Additionally, multiple bending elements 312 are formed in the middle portion 106, where the bending elements 312 are disposed between adjacent support bands 300, connecting a support band first edge 302 of the support band 300 to a second support band edge 304 of an adjacent support band 300. The bending elements 312 are positioned about the tubular monolithic SMA actuator circumference and between the actuator patterns 108, where the bending element 312 is formed to have lower mechanical stiffness than the actuator pattern 108 to make sure the bending element 300 contributes minimal resistance to the overall motion of the actuator pattern and further the bending element 312 is formed to have a lower electrical resistance relative to the electrical resistance of the actuator pattern 108 to prevent unnecessary heating in the bending element 312. An electrode is optionally formed in the first end 102 or in the second end 104 of the monolithic SMA actuator 108. In this embodiment, an actuator pattern electrode 310 is formed and connected to the actuator pattern second end 308, where electrical continuity exists along the middle portion 106 from the actuator pattern electrode 310 to the first end 102 or to the second end 104 of the tubular monolithic SMA actuator 100. The electrodes are made from the tubular monolithic SMA. This particular embodiment eliminates additional fabrication steps involved in aligning and bonding the SMA actuators 100 with a passive body, therefore it is more efficient and economical to fabricate out of a single monolithic SMA tube. Alternatively, the actuator patterns can be heated indirectly, for example, using a thermistor or other non-contact heating, so there is no need to directly form the electrodes on the actuators.

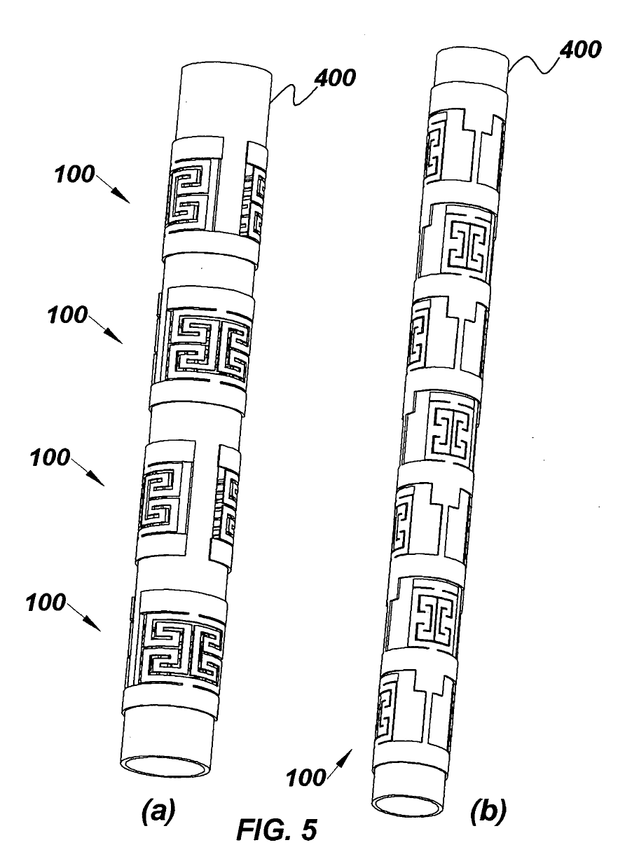

FIGS. 5a and 5b depict perspective views of the tubular monolithic SMA actuator 100 configured with a passive tubular bodies 400 such as a catheter, where FIG. 5a illustrates multiple tubular monolithic SMA actuator 100 similar to those depicted in FIGS. 2-4. FIG. 5b depicts the tubular monolithic SMA actuator 100 of FIG. 4 configured with a passive tubular body 400.

Also contemplated are methods of manufacturing the tubular monolithic SMA actuators described herein.

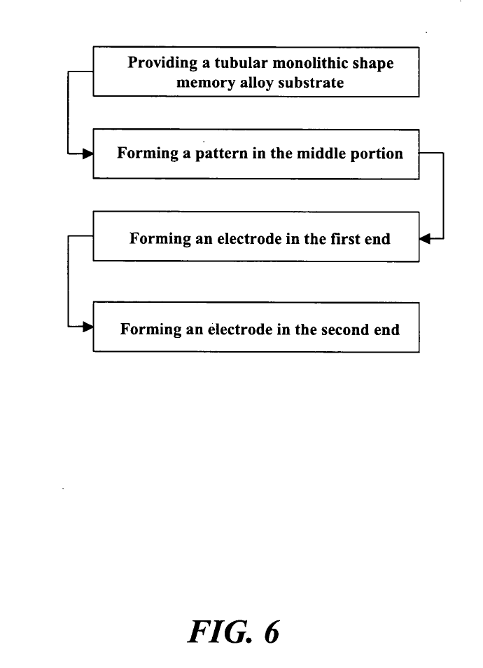

FIG. 6 is a diagram that depicts the steps of a method of fabricating a tubular monolithic SMA actuator 100 like the ones depicted in FIG. 1, which include providing a tubular monolithic SMA alloy substrate, where the SMA alloy can be NiTi, CuAlNi, CuAl, CuZnAl, TiV, or TiNb to name a few. The tubular monolithic SMA substrate has a cross-section shape such as a circle, an ellipse, a square, a rectangle, a parallelogram or a polygon, to name a few. The substrate has a first end 102, a second end 104 and a middle portion 106, and forming an actuator pattern 108 in the middle portion 106. The SMA actuator is fabricated by forming an actuator pattern 108 in the middle portion 106, where the tubular monolithic SMA can be NiTi, CuAlNi, CuAl, CuZnAl, TiV, or TiNb, to name a few. The tubular monolithic SMA has a cross-section shape such as a circle, an ellipse, a square, a rectangle, a parallelogram or a polygon, to name a few. The actuator pattern 108 maintains unity and electrical continuity, along the path of the actuator pattern 108, with the first end 102 and second end 104 of the tubular monolithic SMA actuator 100. The actuator pattern 108 can be a generally Greek key pattern, a zigzag pattern or any irregular pattern for example. An electrode (110, 112) is formed in the first end 102 and in the second end 104 of the tubular monolithic SMA actuator 100. The tubular monolithic SMA actuator 100 is formed using fabrication methods such as laser machining, electric discharge machining, mechanical machining, stamping, dicing and chemical etching. The electrodes (110, 112) are made from the tubular monolithic SMA. In another embodiment, one or more of the electrodes are formed before the actuator pattern 108 is formed in the middle portion 106. Alternatively, the steps do not need to be carried out in this particular order, so the actuator can be formed in any order. Practically the electrode can be positioned in any angle relative to the actuator pattern, and can be optionally formed on one or both ends (102, 104).

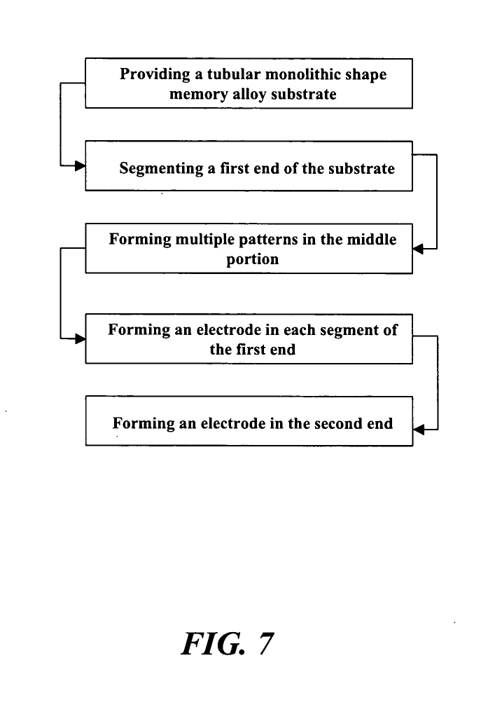

In another embodiment, FIG. 7 is a diagram that depicts the steps of another embodiment of a method of fabricating a tubular monolithic SMA actuator 100, such as depicted in FIGS. 2 and 3, which includes providing a tubular monolithic SMA having a first end 102, a second end 104 and a middle portion 106, where the first end 102 is segmented. The tubular monolithic SMA has a cross-section shape such as a circle, an ellipse, a square, a rectangle, a parallelogram or a polygon, for example, where the tubular monolithic SMA can be NiTi, CuAlNi, CuAl, CuZnAl, TiV, or TiNb, to name a few. A pair of actuator patterns 108 are formed in the middle portion 108, where the middle portion maintains unity and electrical continuity, along the paths of the actuator patterns, with each segment of the first end 102 and with the second end 104 of the tubular monolithic SMA actuator 100. The actuator pattern 108 can be a generally Greek key pattern, a zigzag pattern or any irregular pattern for example. An electrode (110, 112) is formed in each segment of the first end 102, and an electrode (110, 112) is formed in the second end 104. In this embodiment of the method of forming the tubular monolithic SMA actuator 100, machining methods such as laser machining, electric discharge machining, mechanical machining, stamping, dicing and chemical etching can be used, to name a few. The electrodes (110, 112) are made from the tubular monolithic SMA. Alternatively, the steps do not need to be carried out in this particular order, so the actuator can be formed in any order. Practically the electrode can be positioned in any angle relative to the actuator pattern, and can be optionally formed on one or both ends (102, 104).

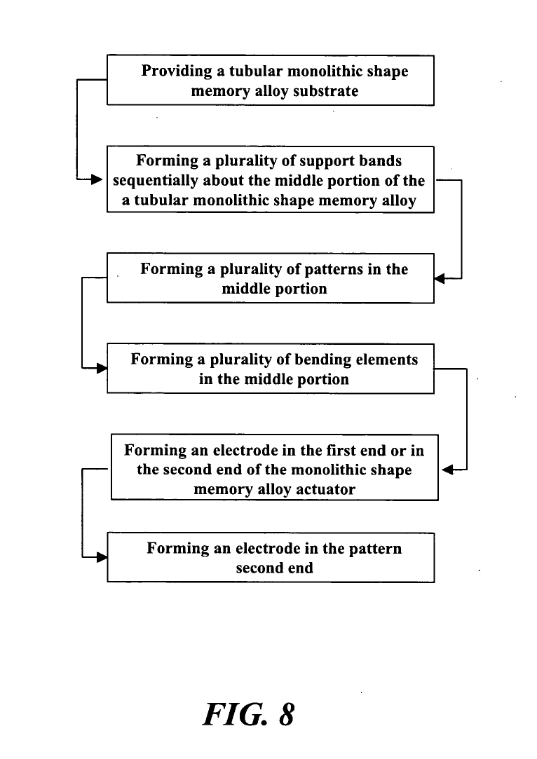

In another embodiment, FIG. 8 is a diagram that depicts the steps of the method of fabricating a tubular monolithic SMA actuator 100 such as depicted in FIG. 4, where the method includes providing a tubular monolithic SMA having a first end 102, a second end 104 and a middle portion 106, where the first end 102, second end 104 and middle portion 106 have a predetermined electrical resistance and a mechanical stiffness. The tubular monolithic SMA has a cross-section shape such as a circle, an ellipse, a square, a rectangle, a parallelogram or a polygon, for example, where the tubular monolithic SMA can be NiTi, CuAlNi, CuAl, CuZnAl, TiV, or TiNb, to name a few. Multiple support bands 300 are formed sequentially about the middle portion 106 of the a tubular monolithic SMA actuator 100, where the support band 300 has a support band first edge 302 and a support band second edge 304. Multiple actuator patterns 108 are formed in the middle portion 106, where the actuator pattern 108 has an actuator pattern first end 306 connected to the support band first edge 302 and an actuator pattern second end 308 connected to an actuator pattern electrode 310 that is detached from the middle portion 106. The actuator pattern 108 has a generally Greek key pattern, a zigzag pattern or any irregular pattern, for example. Multiple bending elements 312 are formed in the middle portion 106, where the bending elements 312 have a bending element first end 314 attached to the support band first edge 302 and a bending element second end 316 attached to an adjacent support band second edge 304. An electrode (110 or 112) is formed in the first end or in the second end of the tubular monolithic SMA actuator. An actuator pattern electrode 310 is formed in the actuator pattern second end 308, where electrical continuity exists along the middle portion 106 from the actuator pattern second end 308 to the first end 102 or the second end 104 of the tubular monolithic SMA actuator 100. The electrodes (110 or 112, 310) are made from the tubular monolithic SMA. The tubular monolithic SMA actuator 100 is formed using fabrication methods such as laser machining, electric discharge machining, mechanical machining, stamping, dicing or chemical etching, for example. Alternatively, the steps do not need to be carried out in this particular order, so the actuator can be formed in any order. Practically the electrode can be positioned in any angle relative to the actuator pattern, and can be optionally formed on one or both ends (102, 104).

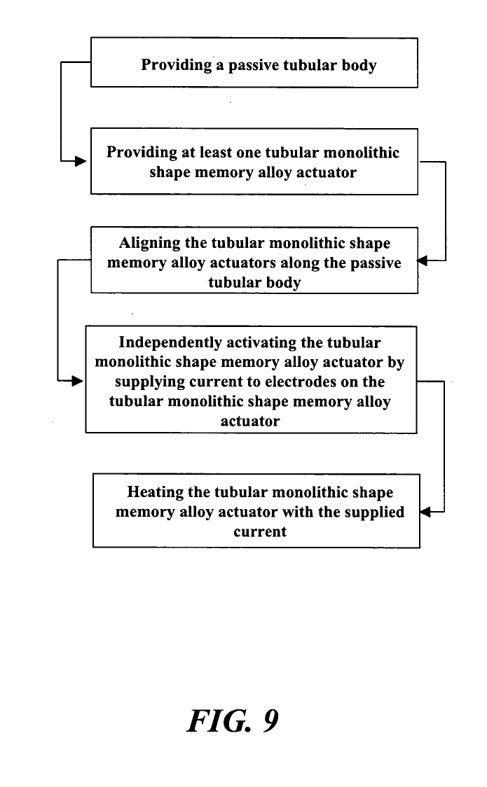

In another embodiment, FIG. 9 is a diagram that depicts the steps of the method of actuating a tubular monolithic SMA actuator 100 is presented, such as depicted in FIG. 5a, where the method includes providing a passive tubular body 400, providing at least one tubular monolithic SMA actuator 100 and aligning the tubular monolithic SMA actuators 100 along the passive tubular body 400. The method further includes independently activating the tubular monolithic SMA actuators 100 by supplying current to electrodes (110, 112) on the tubular monolithic SMA actuators 100, and heating the tubular monolithic SMA actuator 100 with the supplied current, where the heat causes the tubular monolithic SMA actuator 100 to bend the passive tubular body 400 in desired a direction and to a desired degree. In this embodiment, multiple tubular monolithic SMA actuators 100 envelope a passive body 400 having a generally tubular shape with a cross-section similar to the tubular monolithic SMA actuators 100, where the passive tubular body 400 is made from material such as polymers, metal alloy or nitinol, to name a few. Here, the passive tubular body 400 has a lower mechanical stiffness than the tubular monolithic SMA actuator 100.

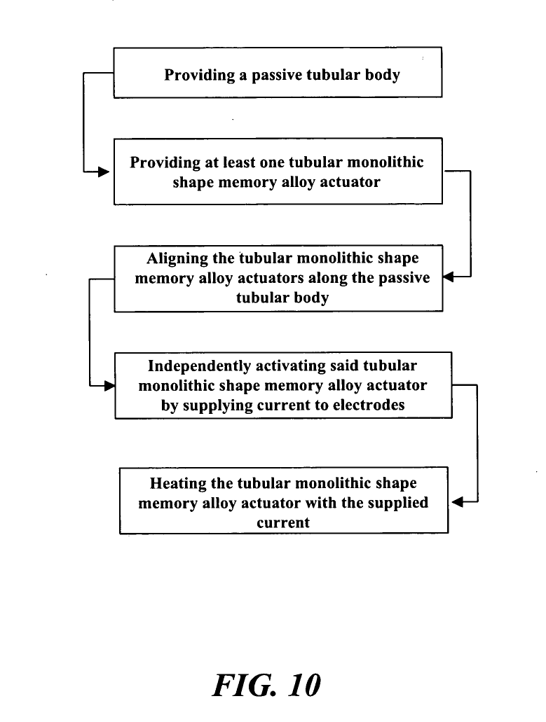

In another embodiment, FIG. 10 is a diagram that depicts the steps of the method of actuating a tubular monolithic SMA actuator 100 is presented, such as depicted in FIG. 5b, where the method includes providing a passive tubular body 400, providing a tubular monolithic SMA actuator 100 and aligning the tubular monolithic SMA actuator 100 along the passive tubular body 400. The method further includes independently activating the tubular monolithic SMA actuators 100 by supplying current to electrodes (110 or 112, 310) on the tubular monolithic SMA actuators 100, and heating the tubular monolithic SMA actuator 100 with the supplied current, where the heat causes the tubular monolithic SMA actuator 100 to bend the passive tubular body 400 in desired a direction and to a desired degree. In this embodiment, the tubular monolithic SMA actuator 100 envelopes a passive body 400 having a generally tubular shape with a cross-section similar to the tubular monolithic SMA actuator 100, where the passive tubular body 400 is made from material such as polymers, metal alloy or nitinol, to name a few. Here, the passive tubular body 400 has a lower mechanical stiffness than the tubular monolithic SMA actuator 100.

The present invention has now been described in accordance with several exemplary embodiments, which are intended to be illustrative in all aspects, rather than restrictive. Thus, the present invention is capable of many variations in detailed implementation, which can be derived from the description contained herein by a person of ordinary skill in the art.

All such variations are considered to be within the scope and spirit of the present invention as defined by the following claims and their legal equivalents.

What is claimed is:

1. A tubular monolithic shape memory alloy actuator, comprising:
a. a tubular monolithic shape memory alloy having a first end, a second end and a middle portion, wherein said middle portion is formed into an actuator pattern that maintains unity and electrical continuity along the path of said actuator pattern with said first end and said second end of said tubular monolithic shape memory alloy actuator; and
b. at least one electrode formed in said first end or said second end.

2. The tubular monolithic shape memory alloy actuator of claim 1, wherein said tubular monolithic shape memory alloy has a cross-section shape comprising a circle, an ellipse, a square, a rectangle, a parallelogram and a polygon.

3. The tubular monolithic shape memory alloy actuator of claim 1, wherein said first end, said second end and said middle portion are of generally partial-tubular shape.

4. The tubular monolithic shape memory alloy actuator of claim 1, wherein said actuator pattern comprises a generally Greek key pattern or a zigzag pattern.

5. The tubular monolithic shape memory alloy actuator of claim 1, wherein said first electrode and said second electrode are made from said tubular monolithic shape memory alloy.

6. The tubular monolithic shape memory alloy actuator of claim 1, wherein said shape memory alloy comprises NiTi, CuAlNi, CuAl, CuZnAl, TiV, and TiNb.

7. A tubular monolithic shape memory alloy actuator, comprising:
a. a tubular monolithic shape memory alloy having a first end, a second end and a middle portion, wherein said first end is segmented, and wherein said middle portion is formed in a plurality of actuator patterns that maintain unity and electrical continuity along the paths of said actuator patterns with each said segmented first end and said second end of said tubular monolithic shape memory alloy actuator; and
b. forming at least one electrode in each said segment of said first end; and
c. optionally forming an electrode in said second end.

8. The tubular monolithic shape memory alloy actuator of claim 7, wherein said tubular monolithic shape memory alloy has a cross-section shape comprising a circle, an ellipse, a square, a rectangle, a parallelogram and a polygon.

9. The tubular monolithic shape memory alloy actuator of claim 7, wherein said segmented first end is of generally partial-tubular shape.

10. The tubular monolithic shape memory alloy actuator of claim 7, wherein said second end is of generally tubular shape having an open span.

11. The tubular monolithic shape memory alloy actuator of claim 7, wherein said second end is of generally tubular shape.

12. The tubular monolithic shape memory alloy actuator of claim 7, wherein said actuator pattern comprises a generally Greek key pattern or a zigzag pattern.

13. The tubular monolithic shape memory alloy actuator of claim 7, wherein said first electrode and said second electrode are made from said tubular monolithic shape memory alloy.

14. The tubular monolithic shape memory alloy actuator of claim 7, wherein said shape memory alloy comprises NiTi, CuAlNi, CuAl, CuZnAl, TiV, and TiNb.

15. A tubular monolithic shape memory alloy actuator, comprising;
a. a tubular monolithic shape memory alloy having a first end, a second end and a middle portion, wherein said first end, said second end and said middle portion have an electrical resistance and a mechanical stiffness;
b. a plurality of support bands sequentially formed about said middle portion of said a tubular monolithic shape memory alloy, wherein said support band has a support band first edge and a support band second edge;
c. a plurality of actuator patterns formed in said middle portion, wherein said actuator pattern has an actuator pattern first end connected to said support band first edge and an actuator pattern second end connected to an actuator pattern electrode, where said actuator pattern electrode is detached from said middle portion;
d. a plurality of bending elements formed in said middle portion, wherein said bending elements have a bending element first end attached to said support band first edge and a bending element second end attached to an adjacent said support band second edge;
e. an electrode formed in said first end or in said second end of said monolithic shape memory alloy actuator; and
f. an electrode formed in said actuator pattern second end, wherein electrical continuity exists along said middle portion from said actuator pattern second end to said first end or said second end.

16. The tubular monolithic shape memory alloy actuator of claim 15, wherein said actuator pattern is formed to have a higher electrical resistance relative to said electrical resistance of said middle portion;

17. The tubular monolithic shape memory alloy actuator of claim 15, wherein said bending elements are positioned about said tubular monolithic SMA actuator circumference and between said actuator patterns;

18. The tubular monolithic shape memory alloy actuator of claim 15, wherein said bending element is formed to have lower mechanical stiffness than said support band edge;

19. The tubular monolithic shape memory alloy actuator of claim 15, wherein said bending element is formed to have a lower electrical resistance relative to said electrical resistance of said actuator pattern;

20. The tubular monolithic shape memory alloy actuator of claim 15, wherein said electrodes are made from said tubular monolithic shape memory alloy.

21. The tubular monolithic shape memory alloy actuator of claim 15, wherein said tubular monolithic shape memory alloy has a cross-section shape comprising a circle, an ellipse, a square, a rectangle, a parallelogram and a polygon.

22. The tubular monolithic shape memory alloy actuator of claim 15, wherein said actuator pattern comprises a generally Greek key pattern and a zigzag pattern.

23. The tubular monolithic shape memory alloy actuator of claim 15, wherein said shape memory alloy comprises NiTi, CuAlNi, CuAl, CuZnAl, TiV, and TiNb.

24. A method of fabricating a tubular monolithic shape memory alloy actuator, the method comprising:
a. providing a tubular monolithic shape memory alloy substrate having a first end, a second end and a middle portion;
b. forming an actuator pattern in said middle portion wherein said actuator pattern maintains unity and electrical continuity along the path of said actuator pattern with said first end and said second end of said tubular monolithic shape memory alloy actuator; and
c. forming at least one electrode in said first end or said second end.

25. The method according to claim 24, wherein said tubular monolithic shape memory alloy actuator is formed using fabrication methods comprising laser machining, electric discharge machining, mechanical machining, stamping, dicing and chemical etching.

26. The method according to claim 24, wherein said electrodes are made from said tubular monolithic shape memory alloy.

27. The method according to claim 24, wherein said tubular monolithic shape memory alloy has a cross-section shape comprising a circle, an ellipse, a square, a rectangle, a parallelogram and a polygon.

28. The method according to claim 24, wherein said actuator pattern comprises a generally Greek key pattern and a zigzag pattern.

29. The method according to claim 24, wherein said shape memory alloy comprises NiTi, CuAlNi, CuAl, CuZnAl, TiV, and TiNb.

30. A method of fabricating a tubular monolithic shape memory alloy actuator, the method comprising:
a. providing a tubular monolithic shape memory alloy substrate having a first end, a second end and a middle portion;
b. segmenting said first end;
c. forming a pair of actuator patterns in said middle portion wherein said middle portion maintains unity and electrical continuity along the paths of said actuator patterns with each said segment of said first end and said second end of said tubular monolithic shape memory alloy actuator;
d. forming at least one electrode in each said segment of said first end; and
e. optionally forming an electrode in said second end.

31. The method according to claim 30, wherein said tubular monolithic shape memory alloy actuator is formed using machining methods comprising laser machining, electric discharge machining, mechanical machining, stamping, dicing and chemical etching.

32. The method according to claim 30, wherein said electrodes are made from said tubular monolithic shape memory alloy.

33. The method according to claim 30, wherein said tubular monolithic shape memory alloy has a cross-section shape comprising a circle, an ellipse, a square, a rectangle, a parallelogram and a polygon.

34. The method according to claim 30, wherein said actuator pattern comprises a generally Greek key pattern and a zigzag pattern.

35. The method according to claim 30, wherein said shape memory alloy comprises NiTi, CuAlNi, CuAl, CuZnAl, TiV, and TiNb.

36. A method of fabricating a tubular monolithic shape memory alloy actuator, the method comprising:
a. providing a tubular monolithic shape memory alloy having a first end, a second end and a middle portion, wherein said first end, said second end and said middle portion have an electrical resistance and a mechanical stiffness;
b. forming a plurality of support bands sequentially about said middle portion of said a tubular monolithic shape memory alloy, wherein said support band has a support band first edge and a support band second edge;
c. forming a plurality of actuator patterns in said middle portion, wherein said actuator pattern has an actuator pattern first end connected to said support band first edge and an actuator pattern second end connected to an actuator pattern electrode, where said actuator pattern electrode is detached from said middle portion;
d. forming a plurality of bending elements in said middle portion, wherein said bending elements have a bending element first end attached to said support band first edge and a bending element second end attached to an adjacent said support band second edge;
e. forming an electrode in said first end or in said second end of said monolithic shape memory alloy actuator; and
f. forming an actuator pattern electrode in said actuator pattern second end, wherein electrical continuity exists along said middle portion from said actuator pattern second end to said first end or said second end.

37. The method according to claim 36, wherein said tubular monolithic shape memory alloy actuator is formed using fabrication methods comprising laser machining, electric discharge machining, mechanical machining, stamping, dicing and chemical etching.

38. The method according to claim 36, wherein said electrodes are made from said tubular monolithic shape memory alloy.

39. The method according to claim 36, wherein said tubular monolithic shape memory alloy has a cross-section shape comprising a circle, an ellipse, a square, a rectangle, a parallelogram and a polygon.

40. The method according to claim 36, wherein said actuator pattern comprises a generally Greek key pattern and a zigzag pattern.

41. The method according to claim 36, wherein said shape memory alloy comprises NiTi, CuAlNi, CuAl, CuZnAl, TiV, and TiNb.

42. A method of actuating a tubular monolithic shape memory alloy actuator, the method comprising:
a. providing a passive tubular body;
b. providing at least one tubular monolithic shape memory alloy actuator;
c. aligning said tubular monolithic shape memory alloy actuators along said passive tubular body;
d. independently activating said tubular monolithic shape memory alloy actuator by supplying current to electrodes on said tubular monolithic shape memory alloy actuator; and
e. heating said tubular monolithic shape memory alloy actuator with said supplied current, wherein said heat causes said tubular monolithic shape memory alloy actuator and said passive tubular body to bend in desired a direction and to a desired degree.

43. The method of actuating a tubular monolithic shape memory alloy actuator of claim 41, wherein said tubular monolithic shape memory alloy actuator envelopes a passive body having a generally tubular shape with a cross-section similar to said tubular monolithic shape memory alloy actuator.

44. The method of actuating a tubular monolithic shape memory alloy actuator of claim 42, wherein said passive body is made from material comprising polymers, metal alloy and nitinol.

45. The method of actuating a tubular monolithic shape memory alloy actuator of claim 24, wherein said passive body has a lower mechanical stiffness than said tubular monolithic shape memory alloy actuator.
